(19) United States
(12) Patent Application Publication
(10) Pub. No.: US 2016/0083091 A1
(43) Pub. Date: Mar. 24, 2016

(54) In-Vehicle Entertainment System

(71) Applicant: RETAIL IN MOTION, Dublin (IE)

(72) Inventor: Michael Joseph Elias, Dublin (IE)

(21) Appl. No.: 14/892,245

(22) PCT Filed: May 21, 2014
(86) PCT No.: PCT/EP2014/060464

§ 371 Date: Nov. 19, 2015

(30) Foreign Application Priority Data
May 22, 2013 (GB) 1309259.8

(51) Int. Cl. B64D 11/00; H04W 84/12; H04L 29/08

(52) U.S. Cl. CPC B64D 11/0015; H04L 67/12; H04W 84/12

(57) ABSTRACT

An in-vehicle entertainment broadcasting system for a vehicle which is portable to allow movement between vehicles and wherein data is broadcastable by the system so that it is accessible by wireless devices within the vehicle, wherein the system is housed within a portable enclosure dimensioned to be accommodated into a pre-existing compartment within the vehicle.

### FIELD OF THE INVENTION

The invention relates to the field of in-vehicle entertainment. In particular, in relates to the provision of user accessible information and entertainment content to passengers in commercial vehicles such as aircraft.

### BACKGROUND TO THE INVENTION

In-vehicle entertainment is frequently provided to passengers on aeroplanes. Different degrees of sophistication of in-vehicle entertainment are available and the degree of sophistication will depend on factors such as the age of the aeroplane, the model of the aeroplane as well as the airline carrier operating the flight.

Very basic entertainment in the form of a viewable screen allowing no user interaction has been available for many years. This can take the form of programming fed to one or a number of screens located within the cabin of an aircraft which are viewable by the passengers. Passengers are provided with individual headsets which they can use if they wish to listen to the accompanying audio track of the provided visual entertainment.

More advanced entertainment systems provide each individual passenger with their own individual screen. The passenger has control over what they view on the screen. Different types of such systems are available, from a very basic set of programming to more advanced systems offering passengers the choice of a large number of audio or visual entertainments which they can control utilizing their own handset or through a touch screen operation.

Further entertainments, in the form of onboard wireless connections are also available. This allows individual passengers to access the onboard wireless connection using their own laptop, tablet, smartphone or similar device.

The above systems provide in-vehicle entertainment with varying degrees of sophistication. Providing such systems can come with a considerable degree of expense as they must be hardwired into the aircraft. The nature of the installation will also differ between models of aircraft and may have to be tailored to suit individual carriers needs. Updating or upgrading such entertainment systems leads to further expense and may result in costly ground time of an aircraft while upgrades are installed and configured.

A device capable of providing in-vehicle entertainment for passengers which is easily installed and maintained would provide an advantage over the state of the art.

### SUMMARY OF THE INVENTION

The present invention comprises an in-vehicle entertainment broadcasting system for a vehicle which is portable to allow movement between vehicles and wherein data is broadcastable by the system such that it is accessible by wireless devices within the vehicle, wherein the system is housed within a portable enclosure dimensioned to be accommodated into a pre-existing compartment within the vehicle.

This provides the advantage of allowing for a self-contained in-vehicle entertainment to be installed within a vehicle without the need to hardwire the entertainment system into the vehicle. The in-vehicle entertainment system may be placed onto a vehicle allowing passengers on the vehicle to access content stored in the system. The system may then be moved between vehicles as required. It further allows for the provision of a self-contained in-vehicle entertainment system in vehicles which do not presently have such capabilities. It further allows for an extremely cost-effective enhancement of existing in-vehicle entertainment systems in vehicles.

The in-vehicle entertainment system may wirelessly transmit data. This allows passengers in the vehicle to wirelessly detect and connect the in-vehicle entertainment system via their own wireless device such as a laptop, smartphone or tablet device. The system may also wireless transmit data to be received by screens or other devices which are fixed in the vehicle.

The in-vehicle entertainment system may wirelessly transmit data via WiFi. This allows WiFi enabled devices to detect and connect to the in-vehicle entertainment system.

The in-vehicle entertainment system may comprise a memory containing media content. This allows the system to host a variety of media content, for example video, music and other data content.

The media content may be downloadable to a wireless device. This allows a passenger to download content from the in-vehicle entertainment system for later access, for example when the passenger has left the vehicle after completing a journey.

The media content may be streamable to a wireless device. This allows a passenger to stream content from the in-vehicle entertainment system while in flight for viewing or listening while in transit.

The in-vehicle entertainment system may further comprise means for allowing access to the Internet. This allows the system to provide access to the Internet so that passengers may connect to the internet via the in-vehicle entertainment system. This allows passengers to perform any web based task such as send receive email and browse websites.

The in-vehicle entertainment system may comprise a portable enclosure that encloses hardware of the system and with one or more antennae on the exterior of the housing. This allows for configuration of data transmission via the antennae.

The in-vehicle entertainment system of may comprise a portable enclosure that encloses hardware of the system and with one or more connectors to allow the system to be plugged into a pre-existing power source within the vehicle so that the system can be powered by the power source. This allows the system to be powered from existing sources within a vehicle. No additional wiring is required to provide power to the system. This allows for ease of installation of the system and further allows for ease of removal of the system for transport to and installation into a further vehicle.

The in-vehicle entertainment system may comprise a portable enclosure that encloses hardware of the system and with one or more connectors to allow the system to be plugged into a pre-existing power source within the vehicle, the pre-existing power source within the vehicle being a power source than can be switched off by a kill switch. This allows a driver of a vehicle, or for example a pilot of an aircraft, to terminate the power source to the system in case of an emergency.

The in-vehicle entertainment system may be adapted to fit into the vehicle in place of another piece of vehicle equipment. This allows for the retro-fitting of the system into a space in a vehicle which was previously occupied by a different piece of equipment. For example, in an aircraft galley, the system may fit into a space previously occupied by an oven. This allows for quick installation of the system into vehicles.

The in-vehicle entertainment system of any preceding claim may comprise an enclosure adapted to fit into a vehicle in place of GAIN equipment. This allows the system to take the place of a piece of GAIN equipment which has been removed from the vehicle.

The in-vehicle entertainment system of may be operable via connection to a standard galley insert, GAIN, interface. This allows the system to benefit from the standardised GAIN mechanical and electrical interfaces. Furthermore, the in-vehicle entertainment system may be dimensioned to fit within a standard galley insert, GAIN. This allows for ease of installation of the system within the standardised GAIN slots in the galleys of commercial vehicles.

The in-vehicle entertainment system may comprise an enclosure dimensioned to fit within a standard galley insert, GAIN slot. This allows the equipment to be readily inserted and removed into a standard sized galley insert slot.

The system may be dimensioned to fit within a size 1 GAIN. The system may further be dimensioned to fit within a size 2 GAIN. Furthermore, the system may be housed within a GAIN. This provides for an extremely compact system which is easily installed in pre-existing standard slots on commercial vehicles. Furthermore, the dimensions of the system mean that it is easily transportable between vehicles.

The in-vehicle entertainment system may be powered via a standard GAIN electrical interface in a vehicle. This provides the advantage of powering the device from a pre-existing connection within a commercial vehicle, thus overcoming the need for additional wiring or power sources within the vehicle. In an aircraft, it further provides the advantage of providing pilot control over power supply to the system, as the GAIN electrical interfaces in a commercial aircraft are controllable from the cockpit of the aircraft.

### BRIEF DESCRIPTION OF THE DRAWINGS

FIG. 1 shows a cross section of a typical aircraft galley including galley inserts; and

FIG. 2 shows the in-vehicle entertainment system housed within a GAIN.

### DETAILED DESCRIPTION

The design and building of commercial aircraft is a highly complex and heavily regulated industry. In order to simplify some aspects of the process, certain industry standards have developed which both adhere to aircraft regulations and allow for a degree of uniformity with the aircraft design process which aids in the reduction of cost and complexity of the design and build of the aircraft.

One such aspect where a standard form is applied is within the aircraft galley. The aircraft galley is an area of the aircraft where in-vehicle attendants perform many of their in-vehicle tasks. The area is provided with an array of facilities. The facilities provided will depend on the type of aircraft and the particular carrier however in general, one can expect to find within the aircraft galley, equipment designed to perform a number of food preparation and food storage tasks. Typical galley equipment would include ovens, microwave ovens, refrigerators and coffee and tea makers.

Galleys on board airplanes are designed with a standard form area which is allocated to galley equipment such as that outlined above in accordance with the on board requirements of a given carrier. Each galley is provided with a number of openings to accept equipment built to this standard form. Such equipment is known as a Galley Insert or GAIN.

GAINs are provided with a common mechanical and electrical interface. These mechanical and electrical interfaces adhere to the standards as defined in Aeronautical Radio, Incorporated (ARINC) standards. ARINC 810 and ARINC 812 describe dimensional and safety requirements for standard interfaces and physical interfaces for galley insert equipment, such as various types of beverage makers. GAIN are categorized by the size of the cavity in which they are inserted: Size 1: Beverage makers, Size 2: Ovens/refrigerators, Size 3: Trolleys, Size 4: Containers.

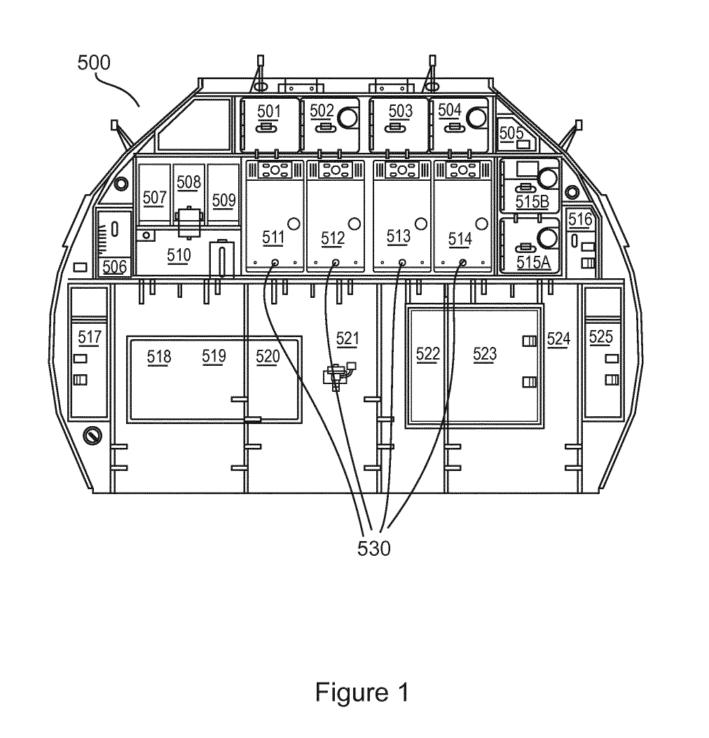

FIG. 1 depicts a typical galley setup on a commercial aircraft. The galley 500 consists of a number of storage compartments, 501 to 510, 515 to 525. The galley 1 is further equipped with a number of galley insert slots 511, 512, 513, 514. These slots 511, 512, 513, 514 are designed to be compatible with a number of galley insert devices such as those outlined above for food preparation. The slots 511, 512, 513, 514 may be GAIN compatible slots meaning that GAIN devices can be readily inserted and removed from the slots. Likewise, once installed in the slots, GAIN devices may be readily powered by coupling of the electrical interface on the device with the electrical interface 530 in the slot.

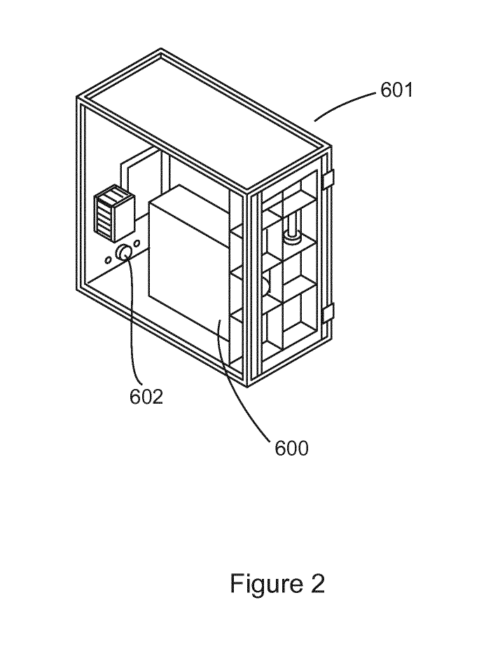

FIG. 2 depicts the in-vehicle entertainment (IFE) system 600 housed within a standard galley insert GAIN 601. By being housed in a GAIN, the IFE system may be readily installed in any aircraft fitted with standard GAIN slots. As such, the system is capable of being fitted into a standard GAIN slot in a galley on a commercial airplane. The IFE system may be dimensioned to be housed within a size 1 or size 2 GAIN. The IFE system comprises a standard GAIN electrical interface 602 for providing electrical power to the device. In a further embodiment of the device, the IFE system may be battery powered.

The IFE system 600 may be configured off-site to provide the required content to passengers, for example as defined by the requirements of a particular carrier. This content may be loaded in to the IFE system in preparation for installation into an aircraft. Alternatively, the device may be first physically installed in the aircraft before being configured with media content.

To install the device, the IFE system 600 is slotted into an available galley insert slot 511, 512, 513, 514 in an aircraft galley. The IFE system 600, due to its standardised dimensions, can be slotted into the galley insert slot and connected to the electrical interface 530 in the slot. Power from the electrical interface 530 of the galley insert slot will thus provide power to the IFE system 600. Once in place in the slot and coupled to the electrical interface 530 of the slot, the IFE system 600 may be powered up. No additional cabling is required to power the IFE system.

Once the IFE system 600 has been powered up, it is ready to deliver content. The IFE system 600 may transmit a signal which is detectable by wireless devices within the aircraft. The IFE system 600 may transmit a WiFi signal or any other type of wireless signal suitable for being received by a passenger device. Thus, content may be delivered wirelessly from the IFE system 600 throughout the aircraft cabin without the need for any additional hard wiring of the system into the aircraft.

Once the passenger device has detected the signal from the IFE system 600, it may choose to select content from the IFE system 600 for download or for streaming.

Once connected to the IFE system 600, the passenger may interact with the content in a manner as defined by the IFE system 600 or by the interaction with the IFE and the passenger device. For example, the IFE system may allow a user to download content to their device. Furthermore, the IFE system 600 allows for streaming of data to the passenger device via a wireless link. In addition to providing access to the stored content of the IFE system, the IFE system may also provide access to the Internet for the passenger devices.

As the IFE system 600 is housed within a standard GAIN, it may be easily removed for upgrading or repair work. It may also be readily switched between aircraft as required.

The content data on the IFE system may be updated by an operator without removal of the device from the galley. Furthermore, the content may be updated remotely.

Aviation regulations dictate that a pilot in the cockpit of an aircraft must have the capability to terminate in-vehicle entertainment in the event of an emergency. The IFE system 600 described may be terminated via existing controls in the cockpit which control power flow to the electrical interfaces 530 for the galley inserts. As such, once the IFE system 600 is installed in an aircraft, no additional wiring is required to provide pilot control over the IFE system.

The above in-vehicle entertainment system has been described in relation to use in a commercial aircraft, however in further embodiments, the system is suitable for use in any type of vehicle, for example, the system is suitable for use in a train, boat or ferry or a variety of road vehicles. The system is particularly suitable for use in commercial vehicles comprising GAIN interfaces.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. An in-vehicle entertainment broadcasting system for a vehicle,
wherein the system is portable to allow movement between vehicles,
wherein data is broadcastable by the system such that the data is accessible by wireless devices within the vehicle, and
wherein the system is housed within a portable enclosure dimensioned to be accommodated into a pre-existing compartment within the vehicle.

2. The in-vehicle entertainment system of claim 1, wherein the system wirelessly transmits data.

3. The in-vehicle entertainment system of claim 1, wherein the system wirelessly transmits data via WiFi.

4. The in-vehicle entertainment system of claim 1, further comprising a memory containing media content.

5. The in-vehicle entertainment system of claim 4, wherein the media content is downloadable to a wireless device.

6. The in-vehicle entertainment system of claim 4, wherein the media content is streamable to a wireless device.

7. The in-vehicle entertainment system of claim 1, further comprising means for allowing access to the Internet.

8. The in-vehicle entertainment system of claim 1, wherein the portable enclosure further comprises one or more antennae on the exterior of the enclosure.

9. The in-vehicle entertainment system of claim 1, wherein the portable enclosure further comprises one or more connectors to allow the system to be plugged into a preexisting power source within the vehicle so that the system can be powered by the power source.

10. The in-vehicle entertainment system of claim 1, wherein the portable enclosure further comprises one or more connectors to allow the system to be plugged into a pre-existing power source within the vehicle, the pre-existing power source within the vehicle being a power source than can be switched off by a kill switch.

11. The in-vehicle entertainment system of claim 1, wherein the system is adapted to fit into the vehicle in place of another piece of vehicle equipment.

12. The in-vehicle entertainment system of claim 1, wherein the enclosure is adapted to fit into the vehicle in place of GAIN equipment.

13. The in-vehicle entertainment system of claim 1, wherein the system is powerable via connection to a vehicle GAIN interface.

14. The in-vehicle entertainment system of claim 1, wherein the enclosure is dimensioned to fit within a standard galley insert, GAIN slot.

15. The in-vehicle entertainment system of claim 14, wherein the enclosure is a size 1 GAIN.

16. The in-vehicle entertainment system of claim 14, wherein the enclosure is a size 2 GAIN.

17. The in-vehicle entertainment system of claim 1, wherein the system is powered via a standard GAIN electrical interface in an aircraft.
